(19) United States
(12) Patent Application Publication
(10) Pub. No.: US 2026/0192800 A1
(43) Pub. Date: Jul. 9, 2026

(54) PRIVACY-PRESERVING CO-LOCATION DETECTION AND COLLISION AVOIDANCE SYSTEMS AND METHODS

(71) Applicant: HAMAD BIN KHALIFA UNIVERSITY, Doha (QA)

(72) Inventors: Roberto Di Pietro, Doha (QA); Pietro Tedeschi, Doha (QA); Savio Sciancalepore, Doha (QA)

(21) Appl. No.: 19/556,429

(22) Filed: Mar. 4, 2026

Related U.S. Application Data
(63) Continuation of application No. 17/943,773, filed on Sep. 13, 2022, now abandoned.
(60) Provisional application No. 63/244,477, filed on Sep. 15, 2021.

(51) Int. Cl. B60W 30/09; B60W 30/095; B60W 60/00; G08G 1/16; H04L 9/08; H04L 9/32

(52) U.S. Cl. CPC B60W 30/09; B60W 30/0956; H04L 9/0863; H04L 9/3271; B60W 60/00276; G08G 1/161

(57) ABSTRACT

A collision avoidance system for vehicles is provided based on wireless communications that causes detection of a co-location of two vehicles to avoid collisions between vehicles (e.g., autonomous vehicles) in a privacy-preserving fashion. The collision avoidance system may deliver and receive messages from other entities on a communication channel of the system. Cryptographic challenges sent and received by vehicles may be encoded and decoded by the collision avoidance system, which may also process the cryptographic responses sent by the vehicles to the cryptographic challenges. The collision avoidance system may achieve all the above operations without revealing the location and the identity of the vehicle to any external party, thus emerging as a real-time, distributed, and privacy-preserving solution.

### CROSS-REFERENCE TO RELATED APPLICATIONS

The present application is a Continuation application of U.S. Ser. No. 17/943,773 filed on Sep. 13, 2022, which claims priority to and the benefit of U.S. Provisional Patent Application 63/244,477, filed Sep. 15, 2021, the entirety of which is incorporated herein by reference.

### BACKGROUND

Autonomous vehicles, including autonomous drones, cars, aircraft, ship, underwater vehicles, etc. are vehicles that are capable of sensing their environment and moving safely with little or no human input. Because of autonomous vehicles' inherent mobile capabilities, as well as the possibility to carry equipment in previously inaccessible locations, autonomous vehicles are increasingly used in a variety of application domains, such as merchandise delivery, health, surveillance, and military use-cases. Being generally devoid of a human on-board or on-board sensors, autonomous vehicles are exposed to the risk of collisions with other objects, as well as with other autonomous vehicles. To this aim, any autonomous vehicle should include a collision avoidance system (e.g., software logic) to identify other nearby vehicles, detect co-location of the autonomous vehicle and another vehicle or object, and that provides automatic communication capabilities with approaching autonomous vehicles to avoid potential collisions.

Typical collision avoidance systems for autonomous vehicles are not privacy preserving with respect to an autonomous vehicle's location while also being capable of universal use with any autonomous vehicle. For instance, many typical collision avoidance systems rely on the indiscriminate clear-text broadcasting of an autonomous vehicle's location or path, such as what is provided by the ADS-B protocol. Some typical collision avoidance systems may not indiscriminately broadcast and autonomous vehicle's location or path, but instead rely on a collaborative arrangement between autonomous vehicles made by the same manufacturer in which each of the vehicles made by the manufacturer have previous knowledge and shared cryptography materials.

Additionally, some typical collision avoidance systems for autonomous vehicles rely on onboard sensors. Not all autonomous vehicles are equipped with cameras or dedicated proximity sensors, however, and thus collision avoidance systems that rely on such cameras or sensors cannot be extended to all autonomous vehicles.

A need therefore exists for a collision avoidance system for autonomous vehicles that solves the above drawbacks.

### SUMMARY

The present disclosure provides a collision avoidance system that preserves the privacy of an autonomous vehicle's location. In some aspects, the collision avoidance system may involve two autonomous vehicles, Vehicle A and Vehicle B, exchanging messages (e.g., RF communications), though the collision avoidance system may be used with other suitable types of vehicles in other aspects. In an example, Vehicle A first maps its own location to a specific tile based on Vehicle A's definition of the tessellation of the space from its own information, such as its speed, its guard space, and constraints on processing time of remote requests. Vehicle A then creates a cryptographic challenge, encoding its location. Vehicle A may also create other materials such as a time validity of Vehicle A's message and/or information about the size of the sensitive area around Vehicle A's location. Vehicle A then creates authentication materials that are necessary to authenticate its message, such as a public-key signature of all the elements in its message. Vehicle A may then deliver a message to a Vehicle B containing the challenge, any other materials created, and the authentication materials.

Vehicle B may receive the message from Vehicle A and may first verify that the challenge included in the message is authenticated and valid. To do this, Vehicle B checks that the signature of the message is authentic, and that the validity time reported in the message is prior to the actual time. If the message is verified, Vehicle B may map its own location into the tessellation instructed by Vehicle A. Vehicle B may then create the response to Vehicle A's challenge by encoding its location and identification information over the received challenge. Then, similar to the process performed by Vehicle A, Vehicle B may map its own location to a specific tile on Vehicle B's definition of the tessellation of the space from its own information, such as its speed, its guard space, and constraints on processing time of remote requests. Vehicle B then creates a cryptographic challenge, optionally some additional materials, and authentication materials. Vehicle B may then deliver the message to Vehicle A.

Upon receiving the message from Vehicle B, Vehicle A may verify the message. If verified, Vehicle A can decrypt the response generated by Vehicle B to its challenge and determine whether there is a match between its location and the location generated by Vehicle B. If there is no match, the Vehicle A does not learn anything more about Vehicle B. If there is a match, then Vehicle A identifies the co-location and can take an appropriate countermeasure, which may include contacting Vehicle B to agree on a shared collision avoidance strategy.

An example method for collision avoidance that preserves the privacy of autonomous vehicles is disclosed. The method may include: mapping, by a first vehicle system having a processor and associated with a first autonomous vehicle, a location information for the first autonomous vehicle on a first space tessellation. The first vehicle system may create a first cryptographic challenge encoding the location information of the first autonomous vehicle. The first vehicle system may generate first authentication materials including at least an encrypted key. Furthermore, the first vehicle system may detect a second autonomous vehicle within a proximity of the first autonomous vehicle. The first vehicle system may transmit the first cryptographic challenge and the first authentication materials to a second vehicle system associated with a second autonomous vehicle.

The method may further include: receiving, by the second vehicle system and from the first vehicle system, a message comprising the first cryptographic challenge and the first authentication materials; verifying, by the second vehicle system, the message; mapping, by the second vehicle system, location information of the second autonomous vehicle; creating, by the second vehicle system, a second cryptographic challenge encoding the location information of the second autonomous vehicle; creating, by the second vehicle system, second authentication materials; and transmitting, by the second vehicle system to the first vehicle system, a response comprising the second cryptographic challenge and the second authentication materials to the first vehicle system.

In some aspects, the method may further include: receiving, by the first vehicle system, the response; verifying, by the first vehicle system, that the response from the second vehicle system is valid; decoding, by the first vehicle system, the second cryptographic challenge to determine the location information of the second autonomous vehicle; and determining, by the first vehicle system, whether a collision will happen based on the location information of the vehicle and the location information of the second vehicle. Furthermore, the first vehicle system and/or the second vehicle system may activate countermeasures in response to determining that a collision will happen. For example, the first vehicle system and/or the second vehicle system may agree on an alternate movement path for one or both of the first autonomous vehicle or the second autonomous vehicle to avoid collision. Also or alternatively, the first vehicle system and/or the second vehicle system may cause the first or second vehicle, respectively, to perform an autonomous evasive maneuver.

Additional features and advantages of the disclosed method and apparatus are described in, and will be apparent from, the following Detailed Description and the Figures. The features and advantages described herein are not all-inclusive and, in particular, many additional features and advantages will be apparent to one of ordinary skill in the art in view of the figures and description. Moreover, it should be noted that the language used in the specification has been principally selected for readability and instructional purposes, and not to limit the scope of the inventive subject matter.

### BRIEF DESCRIPTION OF THE DRAWINGS

FIG. 1 is a block diagram showing an example system for collision avoidance in autonomous vehicles that preserves the privacy of each autonomous vehicle's location and identity, according to an example embodiment of the present disclosure.

FIG. 2 is a block diagram of an example process for an autonomous vehicle (a first vehicle) to avoid collision while preserving the privacy of the first vehicle's location and identity, according to an example embodiment of the present disclosure.

FIG. 3 is a block diagram of an example process for autonomous vehicle systems (second vehicle) in communication with the first vehicle to avoid collision while preserving the privacy of the second vehicle's location and identity, according to an example embodiment of the present disclosure.

FIGS. 4 and 5 are process flow diagrams illustrating an example process between autonomous vehicle systems for preserving privacy at periodic intervals, according to an example embodiment of the present disclosure.

FIG. 6 is a diagram showing an example space tessellation for autonomous vehicles, according to an example embodiment of the present disclosure.

FIGS. 7A-7F are illustrations showing applications of privacy preserving collision avoidance systems for autonomous vehicles in different environments, according to example embodiments of the present disclosure.

### DETAILED DESCRIPTION

As previously discussed, there is a desire and need for effective solutions for autonomous vehicles to identify other vehicles nearby, detect co-location, and automatically communicate to avoid potential collisions, while preserving the anonymity and privacy of the vehicle and/or vehicle owner. Conventional techniques to preserve anonymity, detect co-location, or avoid collisions do not take identity and location privacy into account. For example, some techniques for preserving anonymity can work only in the immediate neighborhood of the autonomous vehicle. Furthermore, other techniques assume that neighboring autonomous vehicles are operated by the same manufacturer, thus having previous knowledge and shared cryptography materials. Other solutions rely on the indiscriminate clear-text sharing of the location or the path of the autonomous vehicle, such as what provided by the ADS-B protocol, and thus these solutions are not privacy-preserving to the location of the autonomous vehicle. Furthermore, many vehicles often do not have a reliable Internet connection, and they operate in an ad-hoc setup, without any chance to interact with other peers.

Various embodiments of the present disclosure address one or more of the above described shortcomings. The present disclosure provides a system and method for avoiding collisions between two vehicles, such as autonomous vehicles. Such systems and methods maintain the privacy of the vehicles involved, and do not compel the involved entities to indiscriminately broadcast the identities of locations of the vehicles. In at least one method involving two autonomous vehicles (a first vehicle and a second vehicle), a first vehicle may map its location information to a space tessellation, create a first cryptographic challenge encoding the location information, and create authentication materials (first authentication materials) (e.g., for another vehicle to access the first cryptographic challenge). The first vehicle may transmit the first cryptographic challenge and the first authentication materials to a second vehicle (e.g., upon detection of the second vehicle within a proximity of the first vehicle).

The second vehicle may receive the communication and verify if the communication from the first vehicle is valid. Furthermore, the second vehicle may also map its location information (e.g., to the existing and/or a new space tessellation), create a second cryptographic challenge encoding the location information of the second vehicle, and create second authentication materials. The second vehicle may respond to the first vehicle by transmitting the second cryptographic challenge and the second authentication materials to the first vehicle.

The first vehicle may receive the response, including the second cryptographic challenge and second authentication materials, the second cryptographic challenge encoding location information of the second vehicle. The first vehicle may verify if the response from the second vehicle is valid, and may decode the second cryptographic challenge to determine the location information of the second vehicle. Furthermore, the first vehicle may determine whether a collision will happen based on the location information of the first vehicle and the location information of the second vehicle. If determined that a collision will happen, the first vehicle and/or the second vehicle may activate appropriate countermeasures as will be discussed herein.

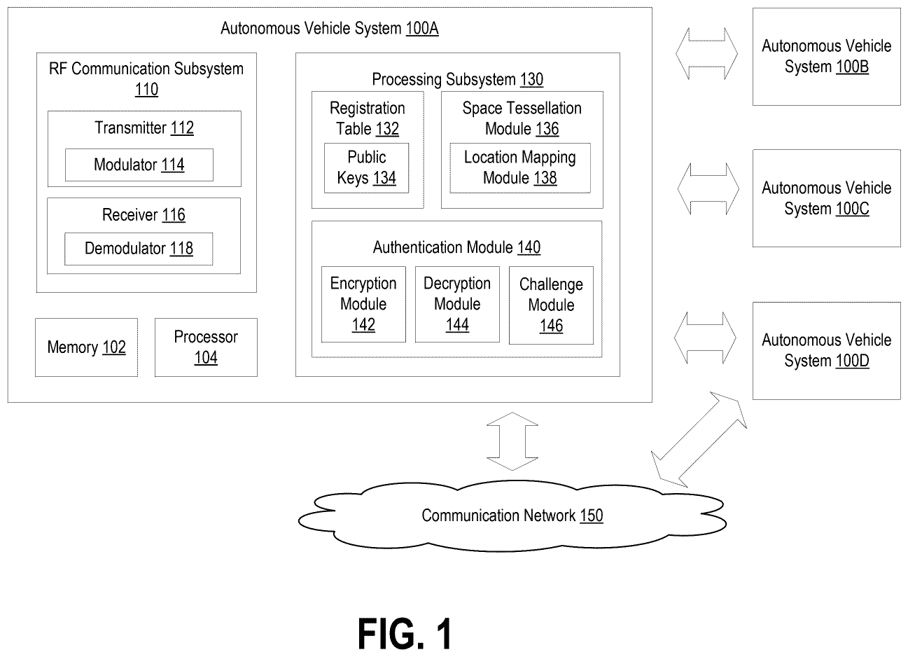

FIG. 1 is a block diagram showing an example system 100 for collision avoidance in autonomous vehicles that preserves the privacy of each autonomous vehicle's location and identity, according to an example embodiment of the present disclosure. Each autonomous vehicle may be a car, aircraft (e.g., plane, drone, etc.), ship, underwater vehicle, or other suitable vehicle. As used herein, a vehicle may refer to not only the autonomous vehicle but also the underlying computing systems and/or subsystems of the autonomous vehicle configured to perform one or more processes described herein. While systems and methods discussed herein are described in relation to autonomous vehicles, it is contemplated that similar systems and/or methods may be applicable to semi-autonomous or non-autonomous vehicles. As such, unless specified otherwise, a vehicle, an autonomous vehicle, a vehicle system, and/or autonomous vehicle system may be used interchangeably. The system 100 may thus include multiple autonomous vehicle systems corresponding to multiple vehicles (e.g., autonomous vehicle systems 100A-100D). The autonomous vehicle systems may communicate wirelessly (e.g., RF communications) with one another according to any suitable protocol and any suitable modulation scheme. In some aspects, the autonomous vehicle systems may communicate over a communication network 150. The communication network 150 can include, for example, the Internet or some other data network, including, but not limited to, any suitable wide area network or local area network. Each of the vehicles may include an autonomous vehicle system (e.g., autonomous vehicle systems 100A-100D) that includes a processor 104 in communication with a memory 102. Each processor 104 may be a CPU, an ASIC, or any other similar device. The processor 104 of each the autonomous vehicle systems may be configured to carry out a location privacy-preserving collision avoidance method provided by the present disclosure.

As shown in FIG. 1, in providing co-location awareness on autonomous vehicles in a privacy-preserving manner, each autonomous vehicle system (e.g., autonomous vehicle system 100) may rely on two or more subsystems, such as the radiofrequency (RF) communication subsystem 110 and the processing subsystem 130. The RF communication subsystem 110 may be used to transmit and receive messages (e.g., via the transmitter 112 and the receiver 116, respectively) to other computing entities in proximity to the autonomous vehicle (e.g., autonomous vehicle systems 100B-100D). The messages may be exchanged over a specific communication medium (e.g., communication medium 150), according to any protocol and any modulation scheme. For example, the transmitter 112 may modulate a message to an RF carrier using a prescribed modulation scheme using modulator 114 and a receiver 116 may demodulate a message received from another vehicle system using demodulator 118.

The processing subsystem 130 can authenticate process, generate, and execute based on messages, create cryptographic challenges (also referred to herein as “challenges”), and compute responses to the challenges according to methods discussed herein. For example, the processing subsystem 130 may further include a registration table 132, a space tessellation module 136, and an authentication module 140. The registration table 132 may comprise a database, repository, or storage of temporary or pseudo identifiers of vehicle systems based on received messages that encrypt or provide pseudonyms for the real identities of vehicles. In some aspects, the processing subsystem 130 may store, for each vehicle, a public key 134 for solving cryptographic challenges associated with the vehicle. The space tessellation module 136 may comprise any software, program, instruction, or code responsible for creating a space tessellation, and for mapping the location of the vehicle in the space tessellation (e.g., via a location mapping module 138). The authentication module 140 may comprise any software, program, instruction, or code that, when executed by a processor 104, may cause the autonomous vehicle system to encrypt or encode information (e.g., a location of a vehicle) (e.g., via encryption module 142), decode or decrypt information (e.g., a location of another vehicle) (e.g., via decryption module 144), create cryptographic challenges (e.g., via challenge module 146), or solve cryptographic challenges (e.g., via challenge module 146). For example, locations for vehicles pertaining to any remote autonomous vehicle system can be determined via a legitimate cryptographic challenge. The RF communication subsystem 110 and the processing subsystem 130 may interact within a generic autonomous vehicle that may be a drone, a car, a ship, or any other autonomous entity.

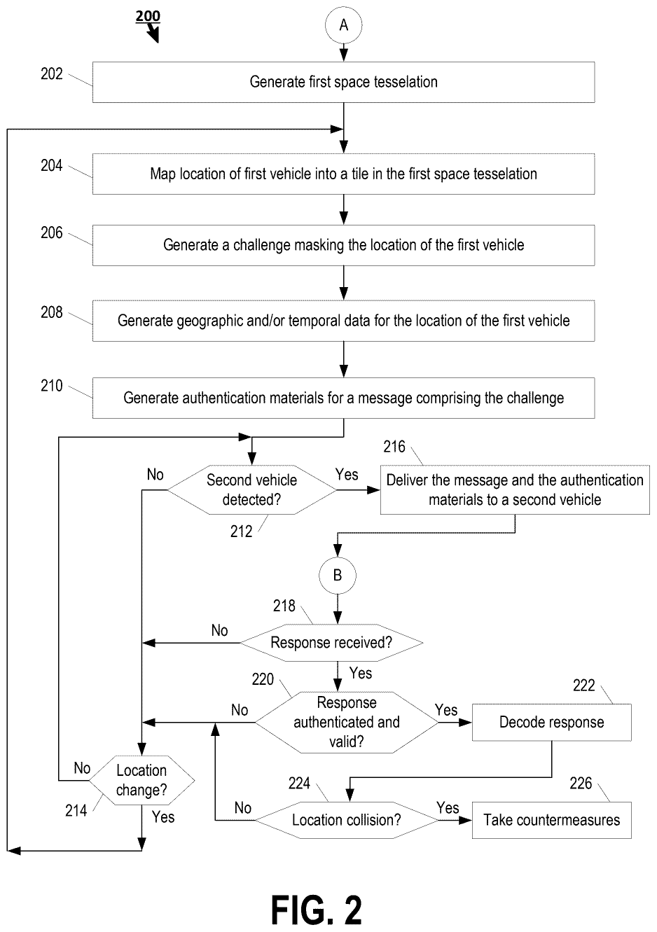

FIG. 2 is a block diagram of an example process 200 for an autonomous vehicle (a first vehicle) to avoid collision while preserving the privacy of the first vehicle's location and identity, according to an example embodiment of the present disclosure. In some embodiments, one or more blocks of process 200 may be performed by an autonomous vehicle system associated with the first vehicle (e.g., via the processor 104 of autonomous vehicle system 100A based on instructions stored in memory 102). For simplicity, “first vehicle” may be used to refer to the autonomous vehicle system performing process 200. In some aspects, the first vehicle may use process 200 to determine if the first vehicle is co-located with a second vehicle different from the first vehicle by exchanging wireless messages, and by not revealing the location of the first or second vehicles. For purposes of demonstration, it may be assumed that during process 200, the first vehicle occupies a location defined by <lat_{A}, lon_{A}, alt_{A}>, where lat_{A}, lon_{A} and alt_{A} refer to the latitude, longitude, and altitude coordinates of the first vehicle.

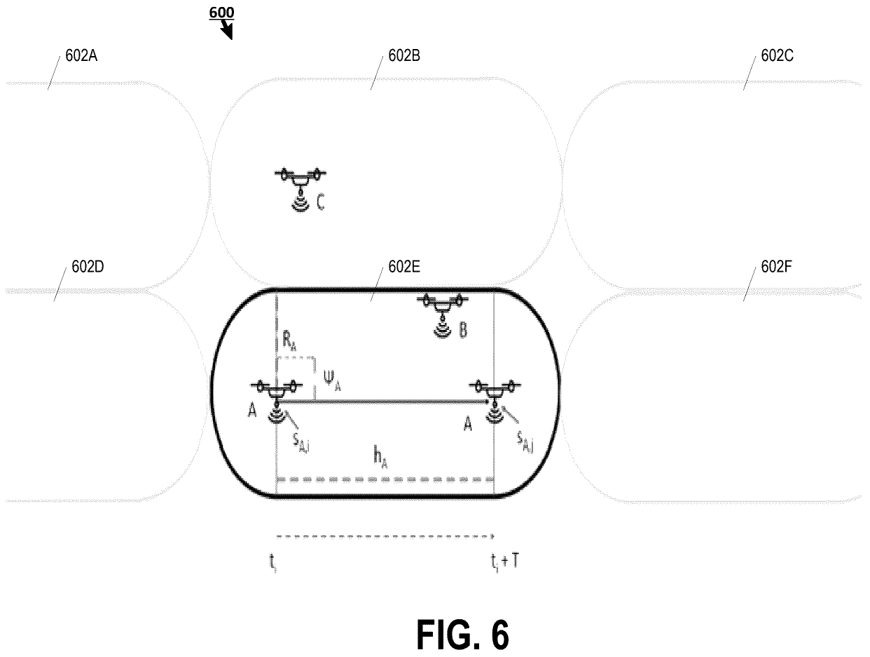

Process 200 may begin with the first vehicle (e.g., autonomous vehicle system 100A) generating a space tessellation (block 202). As will be discussed herein (e.g., in relations to FIG. 6), a space tessellation may refer to a mapping of a physical space, using one or more geometric shapes (i.e., tiles), with no or minimal overlaps and/or gaps. The specific shape of the tile may be customizable, and can be decided according to self-optimality or general optimality criteria, in a way to reduce the risk of false-positive events. The space tessellation defined by the first vehicle may be based on the first vehicle's own information and requirements, such as the speed of the first vehicle, the guard space, and eventual constraints on the processing time of remote requests, as will be discussed herein. Thus, the space tessellation generated by the first vehicle may be distinguishable from other space tessellations generated by other vehicles and may thus be referred to herein as first space tessellation.

The first vehicle maps its own location to a specific tile (block 204). For purposes of explanation, the specific tile for the location of the first vehicle may be referred to herein as loc_{A}. In one embodiment, the processing subsystem 130 of the first vehicle may use the location mapping module 138 to map the location of the first vehicle on a space tessellation generated by the space tessellation module 136. To detect co-location in a privacy-preserving manner, the first vehicle may create a cryptographic challenge, masking and/or encoding the location of the first vehicle (block 206). For example, the challenge module 146 of the processing subsystem 130 may generate a cryptographic challenge whereby the location of the first vehicle may be encoded via the encryption module 142. As will be discussed herein, the cryptographic challenge may be packaged into a message for transmission (e.g., broadcasting).

In some embodiments, the first vehicle can also create additional materials to be encoded with the message, such as geographic and/or temporal data for the location of the first vehicle (block 208). The geographic and/or temporal data may include, for example, the time validity of the message, and any information about the size of the sensitive area around the location of the first vehicle.

Further, the first vehicle may generate authentication materials for authenticating the message comprising the cryptographic challenge (block 210). In some aspects, the authentication materials can be, for instance, a public-key signature of one or more the above described elements (e.g., location, first space tessellation, cryptographic challenge, geographic and/or temporal data, etc.).

In some embodiments, the first vehicle may detect the presence of another vehicle (the second vehicle) within a proscribed proximity without revealing its identity or location and/or becoming aware of the identity or actual location of the second vehicle. For example, the first vehicle may detect the presence of the second vehicle within its tessellation space or within a geographical boundary of the communication network 150. In some aspects, subsequent steps may be based on whether the first vehicle has detected another (i.e., second) vehicle (block 212). If a second vehicle has not been detected, the first vehicle may continue to monitor for any vehicles behind detected (e.g., within a proscribed time) and/or may repeat one or more steps of process 200 if a location of the first vehicle has changed (block 214). For example, if the location of the first vehicle has changed, the first vehicle may need to map the new location into a new tile in the first space tessellation and generate a new cryptographic challenge.

If the second vehicle is detected, the first vehicle may transmit the message and the authentication materials to the second vehicle (block 216). The message may include, for example, the cryptographic challenge, any additional information concerning the first vehicle (e.g., geographic and/or temporal data), and the generated authentication materials. The message may be delivered for over a wired or wireless communication media (e.g., communication network 150). The message can be either broadcast or unicast to a specific autonomous vehicle in proximity to the first vehicle.

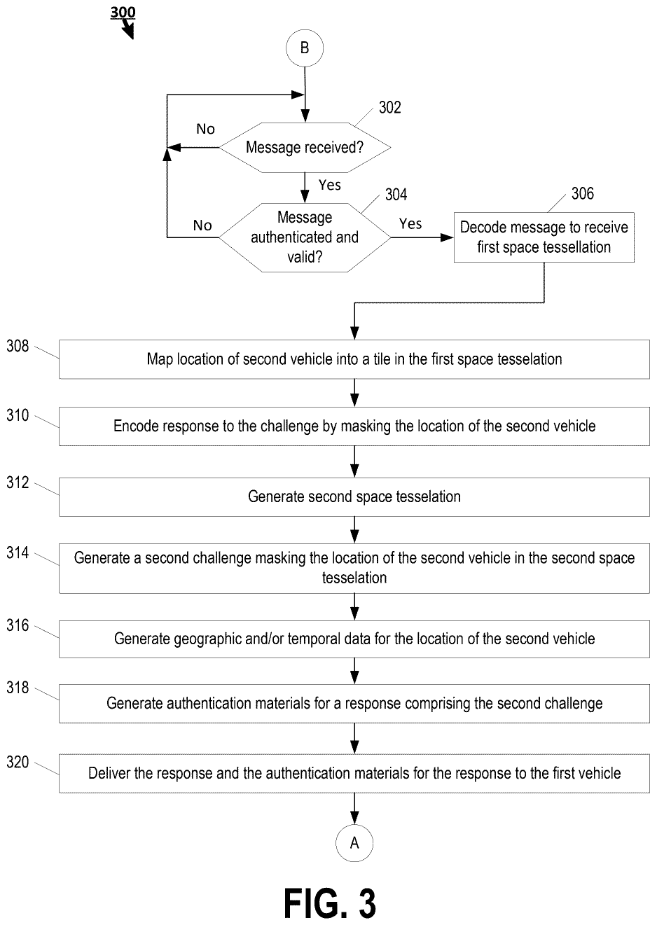

As will be discussed further below, in relation to FIG. 3, the second vehicle may receive the message transmitted by the first vehicle, and may transmit a response back to the first vehicle (after performing one or more steps described in FIG. 3, shown as “B” in FIG. 2). Thus, at block 218, the first vehicle may determine whether a response is received. If no response is received, the first vehicle may continue to monitor for a response and/or may repeat one or more steps of process 200 if the location of the first vehicle has changed.

If a response is received from the second vehicle, the first vehicle may initially verify that the response (including any new challenges contained in the response) is authenticated and valid (block 220). For example, in at least one embodiment, the first vehicle checks (e.g., via the authentication module 140) that the signature of the response is authentic, and that the validity time reported in the response is posterior to the actual time. If the above two checks are successfully completed, the first vehicle can decode and/or decrypt the response generated by the second vehicle (block 222) to its challenge (e.g., via decryption module 144).

The first vehicle may then determine whether there is a location collision (block 224). For example, the first vehicle may verify if there is a match between its own location and the one generated by second vehicle, as will be discussed herein. If there is no location collision (e.g., there is no match in the locations), the first vehicle may not learn anything else about the location of the second vehicle, thus ensuring privacy preservation. In some aspects, the first vehicle may then repeat one or more steps of process 200, for example, to update any changes in the location of the first vehicle.

If there is location collision (e.g., if there is a match in the locations of the first vehicle and the second vehicle), the first vehicle may identify the co-location, and can take the appropriate countermeasures (block 226). For example, the first vehicle may contact the second vehicle and can decide on a shared strategy to avoid the collision (e.g., agree on an evasion maneuver) or the first vehicle may decide to adopt a standalone evasive maneuver, without contacting the autonomous vehicle B.

FIG. 3 is a block diagram of an example process 300 for the second vehicle in communication with the first vehicle to avoid collision while preserving the privacy of the second vehicle's location and identity, according to an example embodiment of the present disclosure. Moreover, as previously mentioned, process 300 may be performed by the second vehicle after the first vehicle has transmitted the message and the authentication materials to the second vehicle (e.g., after block 216, shown as “B” in FIG. 2). In some embodiments, one or more blocks of process 200 may be performed by an autonomous vehicle system associated with the first vehicle (e.g., via the processor 104 of autonomous vehicle system 100A based on instructions stored in memory 102).

Process 300 may begin with the second vehicle monitoring to see whether any message is received (block 302), for example, the message transmitted by the first vehicle in block 216. If the second vehicle receives the message emitted by the first vehicle, the second vehicle may initially verify that the message (e.g., the cryptographic challenge included in the message) is authenticated and valid (block 304). To this aim, the second vehicle may check that the signature of the message is authentic, and that the validity time reported in the message is posterior to the actual time.

If the above two checks are successfully completed, the second vehicle may decode and/or decrypt the message generated by the first vehicle (block 306) (e.g., via decryption module 144). Furthermore, the second vehicle may map its own location, which may be indicated as lat_{B}, lon_{B}, alt_{B}, into the first space tessellation instructed by the first vehicle (block 308). For example, the second vehicle may obtain and/or mark a tile loc_{B}, in the first tessellation space. Then, after obtaining the tile loc_{B}, the second vehicle may encode the response to the cryptographic challenge transmitted by the first vehicle (block 310). For example, the response may involve the encoding, encrypting, and/or masking of the location and identification information of the second vehicle over the received cryptographic challenge.

In some embodiments, the second vehicle may generate its own space tessellation (block 312). The space tessellation may be defined by the second vehicle based on its own information and requirement, such as the speed of the second vehicle (or according to a guideline from a Trusted Party), the guard space, and eventual constraints on the processing time of remote requests. Thus, this space tessellation may be referred to herein as second space tessellation to distinguish from the first space tessellation generated by the first vehicle. In some aspects, the specific shape of the tiles in the second space tessellation may be arbitrary, and can be decided according to self-optimality or general optimality criteria, in a way to reduce the risk of false-positive events.

Similarly to what was previously performed by the first vehicle (e.g., in process 200) to prevent or minimize the risk of collisions, the second vehicle may map its own location to a specific tile in the second space tessellation. The specific tile for the location of the second vehicle may be indicated herein as loc_{B}.

Then, the autonomous vehicle B creates a cryptographic challenge (block 314), which may be referred to as second cryptographic challenge to distinguish from the cryptographic challenge generated by the first vehicle in process 200. In some aspects, the second cryptographic challenge may encode, encrypt, and/or mask the location of the second vehicle in the second space tessellation. As will be discussed, one or more of the second cryptographic challenge, response to the first cryptographic challenge, and the location of the second vehicle may be packaged as a message. Since the message may be transmitted by the second vehicle to the first vehicle (e.g., in response to the original message transmitted by the first vehicle), the message transmitted by the second vehicle may be referred to herein as the response. The second vehicle can also create additional materials to be encoded with the response, such as geographic and/or temporal data for the location of the second vehicle (block 316). These additional materials can include, for example, the time validity of the response, and information about the size of the sensitive area around the location of the second vehicle.

The second vehicle may create authentication materials to allow for an authentication of the response (e.g., by a recipient of the response) (block 318). These authentication materials can be, for instance, a public-key signature of all the elements described above (e.g., the second cryptographic challenge, response to the first cryptographic challenge, the location of the second vehicle, the geographic and/or temporal data associated with the second vehicle, etc.)

Furthermore, the second vehicle may transmit the response, which may include, for example, a response to the cryptographic challenge previously issued by the first vehicle, the second cryptographic challenge, the additional information, and the authentication materials (block 320). Subsequently, the first vehicle may determine whether it has received the response (block 218 of process 200) and may continue with process 200, as previously discussed.

The above described specific challenge-response protocols adopted to protect the locations of the autonomous vehicles (e.g., the first vehicle and the second vehicle) can be of any type, as far as it does not unveil the locations of the participating entities. For example, the above described challenge-response scheme can utilize public key encryption techniques such as the Elliptic Curve Digital Signature Algorithm (ECDSA) scheme. In addition, Zero-Knowledge Proof (ZKP) schemes can be adapted to work effectively in the context defined by processes 200 and 300.

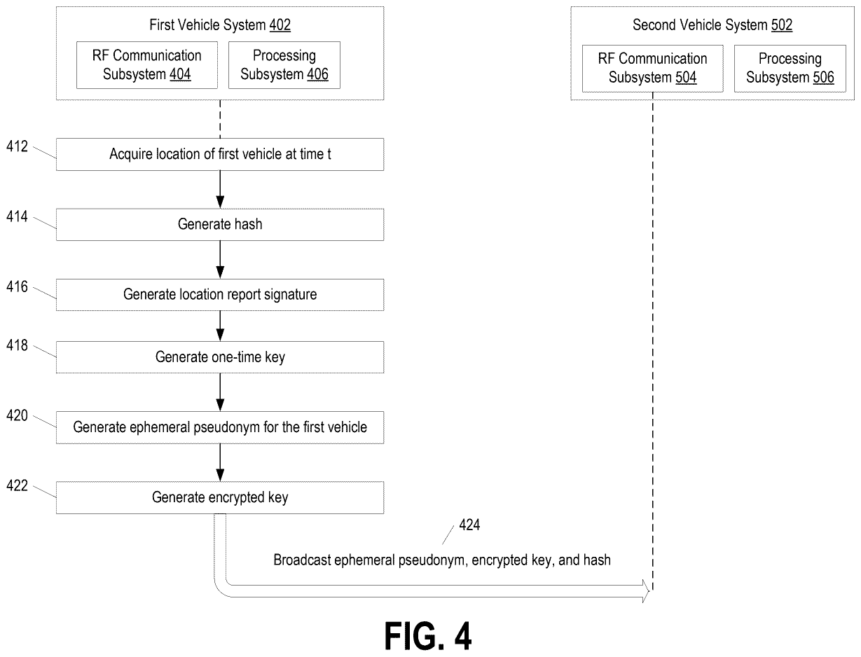

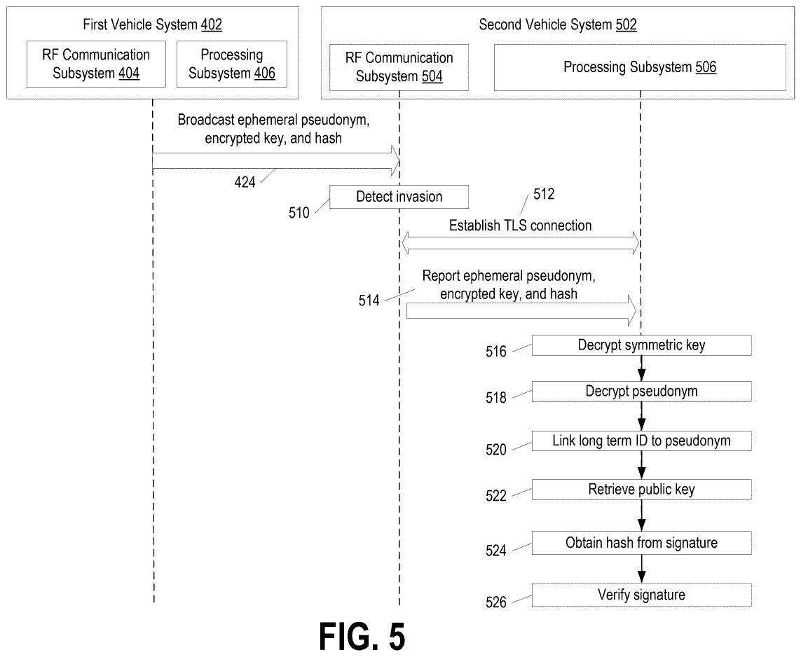

FIGS. 4 and 5 are process flow diagrams illustrating an example process between autonomous vehicle systems for preserving privacy at periodic intervals, according to an example embodiment of the present disclosure. As previously described, each autonomous vehicle system may comprise, for example, an RF communication subsystem and a processing subsystem. For example, the first vehicle system 402 may comprise RF communication subsystem 404 and processing subsystem 406, and the second vehicle system 502 may comprise RF communication subsystem 504 and processing subsystem 506. Various processes, steps, and/or flows discussed in FIGS. 4 and 5 may be performed by or may concern one or more of these autonomous vehicle systems and/or subsystems.

FIG. 4 depicts sequence diagrams of operations executed by the each vehicle at specific times (Tᵢ). For purposes of explanation, each vehicle may be designated as dₙ, and each time the sequence of operations depicted in FIG. 4 may be executed may be designated as Tᵢ. Note that Tᵢ is not fixed, and can range at random in the interval Tᵢ∈[T_{i,MIN}, 1]. To preserve the privacy of the long-term identity of each generic vehicle dₙ, vehicle systems (e.g., first vehicle system 402 and second vehicle system 502) may generate and emit broadcast messages, enabling operators to identify their locations, while still preserving their anonymity. Specifically, as depicted in FIG. 4, a first vehicle system 402 may execute one or more of the following operations.

At the time instant t, the first vehicle, which may be represented as dₙ may occupy the location [lat_{n,t}, lon_{n,t}, alt_{n,t}], i.e. the latitude, longitude, and altitude of dₙ at the time t. This location of the first vehicle at time t may be acquired for subsequent steps (block 412). The first vehicle, dₙ, may generate a hash, h_{n,t}, (e.g., a message digest)(block 414). In some embodiments, the hash may be generated according to the following equation, h_{n,t}=H (IDₙ∥lat_{n,t}∥lon_{n,t}∥alt_{n,t}∥t∥info_{n,t}∥v_{n,t}), where H refers to a generic secure hashing function, info_{n,t} refers to the additional information included by the first vehicle, dₙ, in the packet, v_{n,t} is a nonce, and the operator ∥ refers to the string concatenation. Then, the first vehicle, dₙ may generate a location report signature, indicated herein as β_{n,t} (block 416). For example, the location report signature, δ_{n,t}, may be generated according to the following equation, δ_{n,t}=sign (h_{n,t}, skₙ), where sign may comprise an ECC public-key signature.

Furthermore, the first vehicle, dₙ, may generate a one-time ephemeral key K_{n,t} (block 418). Using such a key, the first vehicle, dₙ, may generate the ephemeral pseudonym c_{n,t} (block 420). For example, the ephemeral pseudonym may be represented as c_{n,t}=S([IDₙ∥δ_{n,t}∥t∥v_{n,t}], K_{n,t}), where S refers to a generic symmetric encryption algorithm.

Then, the first vehicle, dₙ, may generate an encrypted key ρ_{n,t}, (block 422). In some aspects, the encrypted key, ρ_{n,t}, may be a one-time key generated according to the following equation ρ_{n,t}=E (K_{n,t},pk_{A}), where E is a generic public-key encryption operation and pk_{A} is the public-key of an authority, A. As used herein, the authority, A, may comprise a computing system (e.g., an autonomous vehicle system) that has been delegated the privilege to perform security-relevant functions on the computer system of the authority or another computing system. For example, a component of the first vehicle system 402 (e.g., the authentication module 140) may be delegated the authority to perform security-relevant functions concerning its public and/or private keys.

At block 424, the first vehicle, dₙ, may transmit (e.g., broadcast) a packet containing the ephemeral pseudonym c_{n,t}, the encrypted one-time key ρ_{n,t}, and various mandatory information described above (e.g., the latitude lat_{n,t}, longitude lon_{n,t}, altitude alt_{n,t} of the vehicle, the timestamp t, and the additional information info_{n,t}).

A generic continuous integration (CI) operator, indicated herein as r, may continuously listen on the communication network 150 (e.g., wireless channel), looking for RF packets. If the receiver identifies a packet with these information (e.g., through analyzing network traffic), it looks at the reported identity and location of the vehicle. Assuming such a location is outside the protected area, r can simply discard the packet. Otherwise, r triggers operations for a reporting phase of the example process between autonomous vehicle systems for preserving privacy at periodic intervals, as depicted in FIG. 5. In some embodiments, the CI operator, r, may comprise, may be a part of, or may be based on the RF communication subsystem of a vehicle system (e.g., RF communication subsystem 504 of second vehicle system 502). For purposes of explanation, the CI operator, r, may thus be used interchangeably with the RF communication subsystem 504 when describing one or more steps depicted in FIG. 5.

For example, the RF communication subsystem 504, taking the role of the CI operator, r, may detect an invasion of a protected area (e.g., associated with the second vehicle) by an unauthorized vehicle (e.g., the first vehicle) (block 510). This detection may be responsive to the first vehicle, dₙ, broadcasting a message consistent with the format previously described in block 424 (e.g., the ephemeral pseudonym c_{n,t}, the encrypted one-time key ρ_{n,t}, the latitude lat_{n,t}, longitude lon_{n,t}, alti-tude alt_{n,t} of the drone, the timestamp t, and the additional information info_{n,t}). The message may be broadcasted by the first vehicle at time t. The CI operator, r (e.g., RF communication subsystem 504) may thus receive the message, and verify that the location of the first vehicle, expressed in terms of latitude, longitude, and altitude, is being reported to be in a position that is inside a monitored restricted area (e.g., associated with the second vehicle), thereby determining the location of the first vehicle to be an invasion.

At the detection of such an event, the CI operator r may establish a secure connection (e.g., a TLS connection) with an authority A (block 512)). The authority may comprise a computing system or component that has been provided privilege to perform security-relevant functions on the computer system of the authority or another computing system. For example, the authority A, as discussed in block 512, may comprise an authentication module 140 of processing subsystem 506 of the second vehicle system 502. Thus, the CI operator, r (e.g., the RF communication subsystem 504) may report (e.g., relay or transmit) the details of the message detected on the communication channel (e.g., the ephemeral pseudonym, encrypted key, and hash received from the first vehicle), together with any additional local information to the authority (e.g., processing subsystem 506) (block 514).

At the reception of the report from r, the authority, A (e.g., processing subsystem 506) may decrypt the encrypted key to obtain a reconstructed ephemeral key, referred to herein as K_{d,n}, of the first vehicle, dₙ (block 516). For example, the reconstructed ephemeral key may be represented as K_{d,n}=D (ρ_{n,t}, sk_{A}), where D is a public-key decryption function selected in accordance with the public-key encryption technique selected by the first vehicle, dₙ. If the decryption is successful, the authority, A (e.g., processing subsystem 506) may proceed further. Otherwise, the authority may discard the message.

Then, using the reconstructed ephemeral key K_{d,n}, the authority, A (e.g., processing subsystem 506) may decrypt and/or obtain a reconstructed ephemeral pseudonym of the first vehicle, dₙ (block 518). In some aspects, the reconstructed ephemeral key, K_{d,n}, may be used to decrypt the ephemeral pseudonym by applying the operation S c_{n,t}, K_{d,n}=IDₙ∥δ_{n,t}∥t∥v_{n,t} where S refers to the same symmetric encryption algorithms used by dₙ, while the values IDₙ, δ_{n,t}, t, and v_{n,t} refer to the reconstructed values of the long-term identity of dₙ, the location report signature, the generation timestamp, and the random nonce, respectively.

In some embodiments, the authority A (e.g., processing subsystem 506) may verify the consistency of the information retrieved from the ephemeral pseudonym. In particular, the authority A may check that the reconstructed timestamp t matches exactly the value of t delivered in the report by the CI operator r. If the timestamps match, the authority A may proceed further; otherwise, it may discard the message. In some aspects, the authority A may link or associate a long term identification (ID) to the ephemeral pseudonym (block 520). In one embodiment, the long term ID may not reveal the actual identity of the first vehicle but may merely be used as a longer term signifier or indicator of the first vehicle (as opposed to the temporary ephemeral pseudonym) for the purposes of performing collision avoidance processes by the second vehicle system 502.

Then, the authority A (e.g., processing subsystem 506) may look into a local registration table (e.g., registration table 132) for an entry for the first vehicle with a long-term identity IDn. If a match is found, the authority A may retrieve the corresponding registered public key (e.g., public key 134), indicated herein aspkn (block 522). If a match is not found, the authority A may discard the message.

At block 524, the authority A (e.g., processing system 506) may obtain a hash from the signature. For example, using the public key pkₙ just retrieved, the authority A may verify the signature, δ_{n,t} (block 526). In some aspects, the signature δ_{n,t}, can be verified by applying the checksum function verify δ_{n,t}, pkₙ

$$\begin{matrix}? \\ =\end{matrix} {ID}_{n}$$

∥lat_{n,t}∥lon_{n,t}∥alt_{n,t}∥t∥info_{n,t}∥v_{n,t} where verify refers to the public-key signature verification algorithm dual of the public-key signature generation algorithm used by dₙ. If the authority A (e.g., processing subsystem 506) verifies the signature, the report by r can be considered authentic, and the first vehicle with long-term identity IDₙ can be considered accountable for the invasion of the restricted access protected area (e.g., associated with the second vehicle). For example, the owner of the first vehicle can be contacted and blacklisted, based on the specific intrusion. Otherwise, the message may be discarded as not authentic.

FIG. 6 is a diagram showing an example space tessellation 600 for autonomous vehicles, according to an example embodiment of the present disclosure. The space tessellation 600 may comprise a plurality of tiles 602A-602F. Various embodiments of the present disclosure may identify co-location when the location of any autonomous vehicle in the neighborhood is within the same tile of the emitting autonomous vehicle A. Each tile may have a capsule geometrical shape (e.g., as shown in FIG. 6). However, other tile shapes are also possible, including but not limited to a parallelepiped, cubic, and toroid shapes. As depicted in FIG. 6, a space tessellation may be used, for example, where an autonomous vehicle A is moving according to a uniform straight motion with speed vₚ in the period T_{A}. For purposes of demonstration, it may be assumed that T_{A}≤T_{MAX}, where T_{MAX} refers to a maximum allowed time between two consecutive collision avoidance messages emitted by the autonomous vehicle A. When T_{A} is low (e.g., below a predetermined threshold), there may also be a reasonable approximation of any behavior of the autonomous vehicle A.

For purposes of explanation, in one example, it is assumed that the autonomous vehicle A occupies the location s_{A,i}=(x_{A}, y_{A}, z_{A}) at the time instant tᵢ, and the vehicle A is moving with a constant speed v_{A}=(v_{x,A}, v_{y,A}, v_{z,A}) in the time-frame [tᵢ, t_{i+TA}], where T_{A}≤T_{MAX}. Note that, given that A is an autonomous vehicle, equipped with the GPS and a pre-loaded path, it knows in advance with a reasonable accuracy the location it will occupy in the time instant t_{i+TA}, i.e., s_{n,j}. Therefore, according to a uniform straight motion, the distance travelled by the autonomous vehicle A in the time T_{A} can be obtained as h_{A}=v_{A}·T_{A}, and the location occupied by the autonomous vehicle A at the time instant i+T_{A} can be defined as s_{A,i+TA}=s_{A,i}+h_{A}=s_{A,i}+v_{A}·T_{A}.

In order for A to not share the same location with any other autonomous vehicle during the path from s_{A,i} to s_{A,i+TA}, it is contemplated that any possible movement by any autonomous vehicle in the neighborhood in the time period [tᵢ, t_{i+TMAX}] cannot end close to any of the locations that will be occupied by A during this time-frame. A guard space, ψA, of the autonomous vehicle A, may be introduced and may represent the minimum allowed displacement between the autonomous vehicle, A, and any other autonomous vehicle. Defining V_{MAX} as the maximum speed that any autonomous vehicle can have, the autonomous vehicle A can select the tessellation parameter R_{A} as R_{A}≥V_{MAX}·T_{MAX}+ψ_{A}.

Note that, to avoid any physical collision, the above relationship may be valid for any point occupied by the autonomous vehicle during the path. Therefore, to test for the proximity, the vehicle system may test if the current location of any autonomous vehicle does not fall within a capsule geometrical shape, with the spherical bases centered in the points s_{A,i} and s_{A,j}, having radius R_{A} and height 2·R_{A}+h_{A}.

It is contemplated that any autonomous vehicle located outside this capsule of radius R_{A} and height 2·R_{A}+h_{A} may not collide with the autonomous vehicle d_{A}. For example, consider the autonomous vehicle C in capsule 602B. Even if the autonomous vehicle C is moving with the maximum allowed speed V_{MAX} in the maximum time TMAX≥T_{A}, autonomous vehicle C may reach a distance that is higher or equal to the guard space ψ_{A}, thus not causing and/or risking collision with the autonomous vehicle A. Conversely, if any autonomous vehicle is located within capsule 602E, such as the autonomous vehicle B in capsule 602E, there may be a possibility that autonomous vehicle B may collide with autonomous vehicle A. It is also contemplated that the mere detection of a co-location does not necessarily lead to a physical collision. For example, any co-location can detected by the autonomous vehicle A before its movement from the source point towards the destination point. Therefore, any possible collision can be detected (and solved) in advance. However, when the autonomous vehicle A is reasonably sure that no other autonomous vehicle falls within its own tile (e.g., after a time T_{MAX}), autonomous vehicle A can safely move along the intended path.

It is also contemplated that the guard space, ψ_{A}, f the autonomous vehicle A may play a critical role for avoiding collusion. For example, collisions may be avoided if any autonomous vehicle located at a distance less than R_{A} but greater than ψ_{A} can be timely identified, before the occurring of a physical collision. Therefore, an autonomous vehicle system may set this value sufficiently large, in a way to detect a possible collision well before it translates in a real physical collision with the remote autonomous vehicle.

Furthermore, it is contemplated that a space tessellation, as described in various embodiments herein, is not coupled to any specific shape of the space tessellation. Indeed, it could be possible to use also other geometrical shapes, such as a parallelepiped or a cube, whose edges may be chosen to include the afore-mentioned capsule. In addition, when the movement of the autonomous vehicle in the time-frame T_{A} is not uniform, other rotation solids can be used, such as a toroid and other revolutionary shapes.

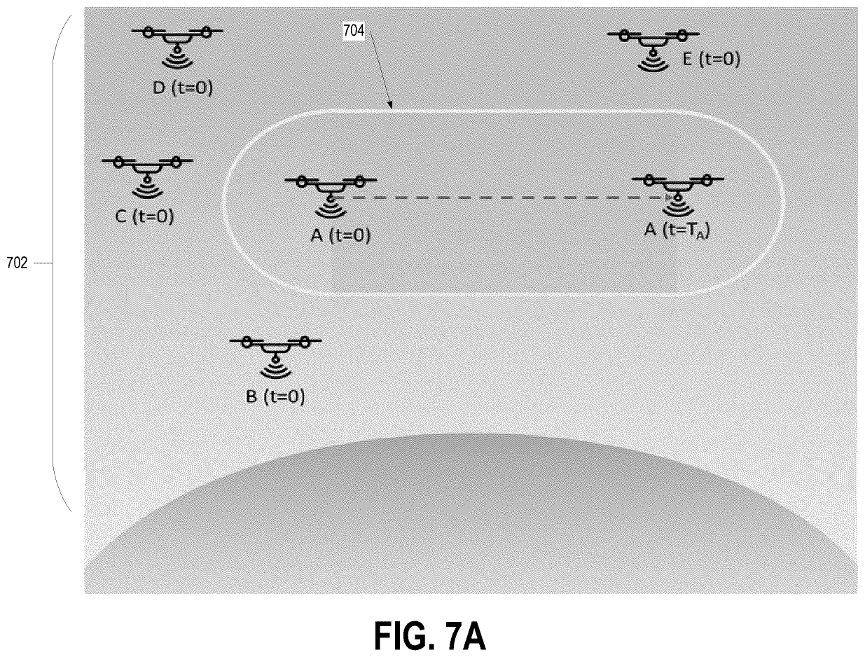

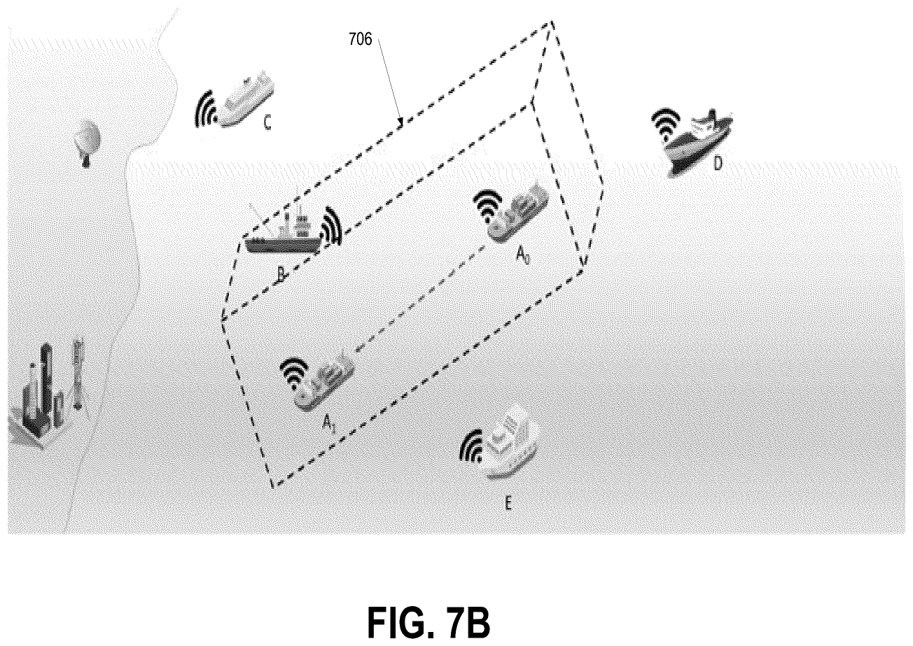

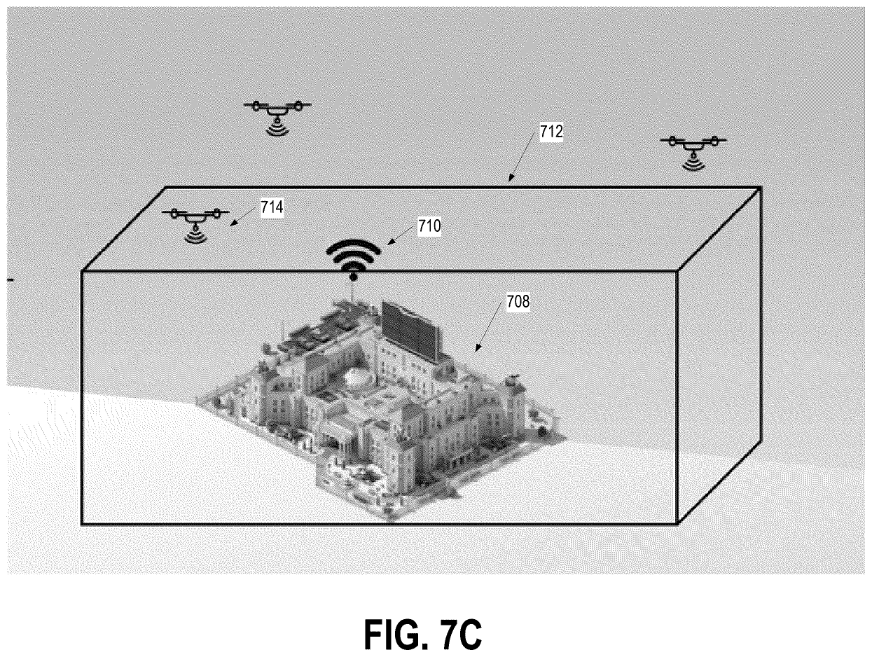

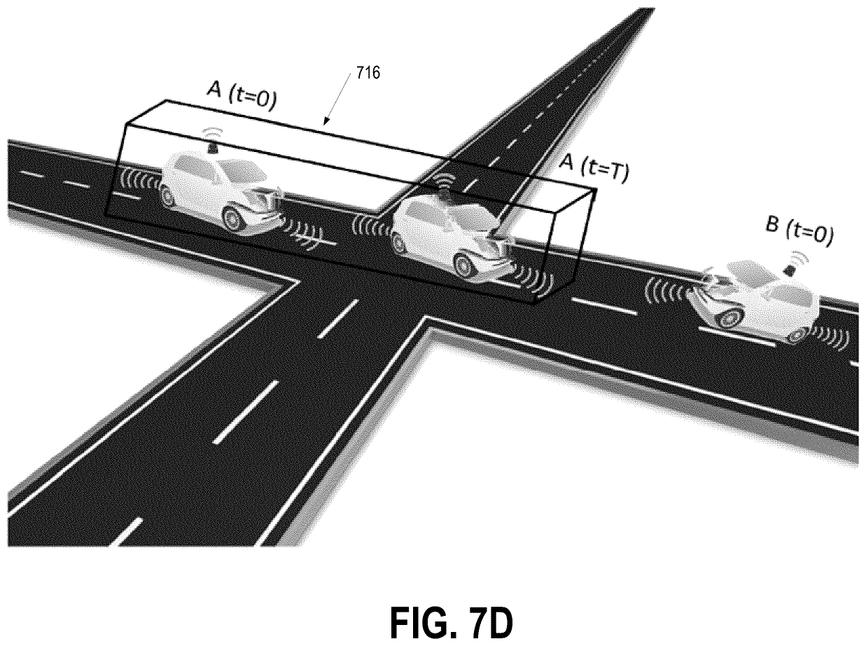

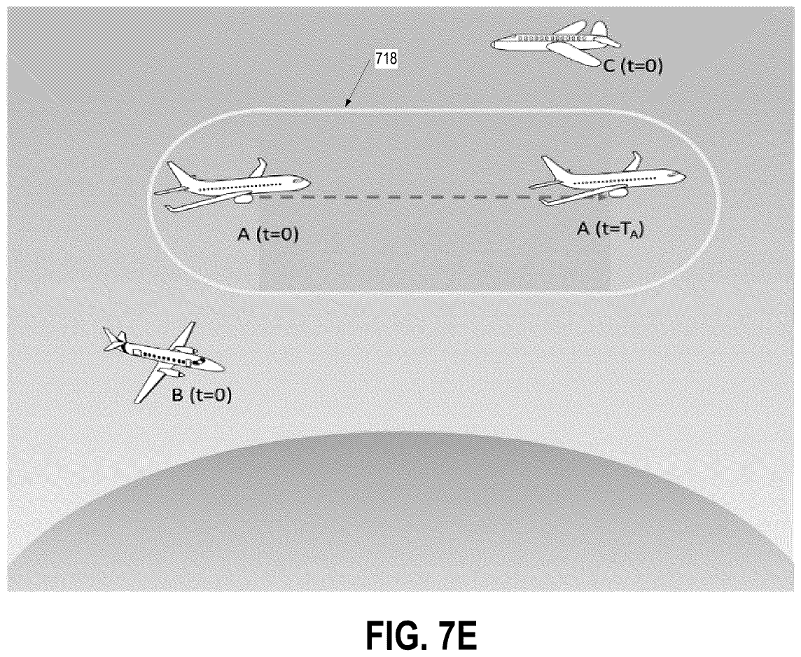

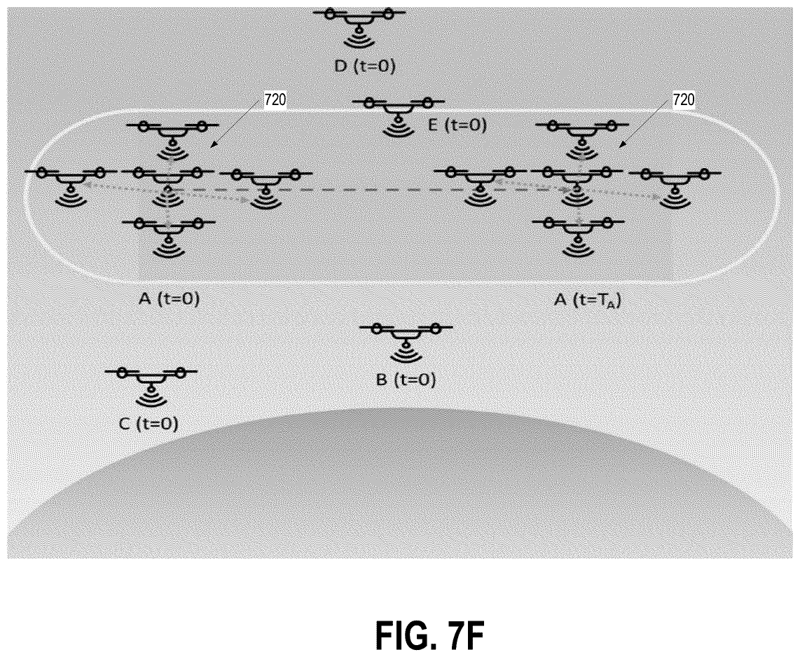

FIGS. 7A-7F are illustrations showing applications of privacy preserving collision avoidance systems for autonomous vehicles in different environments, according to example embodiments of the present disclosure. The different environments may represent different use cases using the privacy-preserving collision avoidance systems and methods discussed herein. For example, applications using the above described systems and methods are illustrated for unmanned aerial vehicle navigation (FIG. 7A), ship navigation (FIG. 7B), sensitive areas surveillance (FIG. 7C), connected cars (FIG. 7D), aircraft (FIG. 7E), and swarms of autonomous vehicles (FIG. 7F).

FIG. 7A illustrates an example embodiment of the above described privacy preserving collision avoidance system applied to multiple autonomous drones. As depicted in FIG. 7A, several autonomous drones are flying in a given area 702, according to a pre-configured path. For purposes of explanation, it can be assumed that the autonomous drone A would like to move from a given source point to a selected destination point over time T_{A} while preserving its long-term identity. Therefore, according to the privacy-preserving collision avoidance solution described herein, the autonomous drone A can map its own origin and destination positions in a tile 704 having the shape of a geometrical capsule, having both the origin and the destination points as the centers of the basis, radius R_{A} and height 2·R_{A}+D_{A}. Furthermore, the vehicle system associated with the autonomous drone A may perform one or more previously described processes, for example in FIG. 2 (e.g., process 200), to identify all the nearby drones falling within the capsule. Further, the autonomous drones may maintain their long-term identities private using one or more steps previously described (e.g., in relation to FIGS. 4 and 5), i.e., they will broadcast only their randomly generated pseudonyms, while keeping private their long-term unique identities.

FIG. 7B illustrates an example embodiment of the above described privacy preserving collision avoidance system applied to ships in the open sea. In line with the scenario previously described, FIG. 7B shows several autonomous ships travelling in a given area in the open sea, according to a pre-configured path. Given that autonomous ships do not have any human personnel on-board, it may be important to detect approaching ships in time, and to avoid collisions while also preserving the long-term identity of the ship. At the same time, it may be important to protect the location of the ship, as malicious entities could eavesdrop on sensitive information (e.g., the long term identity and location of the ship) and attack the ships when offshore. To accomplish the above requirements, previously described embodiments of the privacy preserving collision avoidance systems and methods may be applied to the scenario depicted in FIG. 7B, where the autonomous vehicles are autonomous ships. In particular, the autonomous ship A can map its own path in a given time frame to a tile (e.g., a parallelepiped shaped tile 706 as shown in FIG. 7B), having minimum edge of the basis R_{A} and minimum height 2·R_{A}+D_{A}. Furthermore, a vehicle system associated with the autonomous ship A can perform one or more previously described techniques, for example, process 200 of FIG. 2, to identify all the nearby ships falling within the tile. (e.g., the ship B in FIG. 7B). When a potential collision is identified, then autonomous ship A can contact the ship associated with the collision risk and may establish a new route, in a way to avoid the collision, with the minimum impact on the expected time of arrival. Other ships, not colliding with autonomous ship A, would not know the position of the emitting ship. Further, as previously described in relation to FIGS. 4 and 5, the ships may be able to keep their long-term identities private using the previously described techniques (e.g., the ships will broadcast only their randomly generated pseudonyms, while keeping private their long-term unique identities).

FIG. 7C illustrates an example embodiment of the above described privacy preserving collision avoidance system applied to the detection of the invasion of a sensitive area by a drone. FIG. 7C shows a sensitive area 708, which may include, for example, a military base, a top secret area, or other sensitive target. There may a desire and need to inform nearby autonomous vehicles (e.g., drones, cars, or other mobile entities) to stay outside of the sensitive area. Therefore, a compatible wireless transmitter 710 can be installed within the sensitive area, to broadcast messages, for example, messages transmitted by a vehicle system as previously described in process 200 of FIG. 2. Moreover, the messages may encode and/or encrypt the location of the sensitive area 708 in a tile 712. When an unauthorized entity 714 enters the protected area, the unauthorized entity 714 and/or the sensitive area 708 will detect the collision with the sensitive area 708. This detection may provide the unauthorized entity 714 an opportunity to move away. In some aspects, when a co-location is detected, the only disclosed information is the tile 712 related to the sensitive area. The exact location of any sensitive target 708 within that tile 712 may not be disclosed. Further, according to the previously described processes (e.g., as described in relation to FIGS. 4 and 5), the drones can keep their long-term identities private, i.e., they may only broadcast their randomly generated pseudonyms, while keeping private their long-term unique identities.

FIG. 7D illustrates an example embodiment of the above described privacy preserving collision avoidance system applied to autonomous cars on a road. As shown in FIG. D, an autonomous car A may desire to move from a given source point to a selected destination point in the time T. For purposes of explanation, D may represent the distance between the source and the destination point. In accordance with the privacy-preserving collision avoidance techniques described herein, car A may map its own origin and destination positions in a tile 716 having the shape of a geometrical parallelepiped, having the origin and destination points as the centers of the basis, radius R and height 2·R+D. A vehicle system associated with car A may run previously described processes (e.g., process 200 of FIG. 2) to identify nearby vehicles falling within the tile 716. If a possible collision is detected, countermeasures may be taken. For instance, a dedicated connection may be initiated by A with the colliding vehicle (e.g., vehicle B), to agree on a shared path to avoid any physical collision, or an autonomous evasive maneuver may be initiated. Further, according to the process presented in FIGS. 4 and 5, the autonomous cars may keep their long-term identities private, i.e., they will broadcast only their randomly generated pseudonyms, while keeping private their long-term unique identities.

FIG. 7E illustrates an example embodiment of the above described privacy preserving collision avoidance system applied among aircraft in the air. Aircraft move at very high speed, and detecting a possible collision with other vehicles in advance can be very important to save lives. As shown in FIG. 10, an aircraft A may intend to move from a given source point to a selected destination point over time T. For purposes of explanation, it may be assumed that D represents the distance between the source and the destination point. In accordance with the privacy-preserving collision avoidance techniques described herein, aircraft A may map its own origin and destination positions in a tile 718 having the shape of a geometrical parallelepiped, having the origin and destination points as the centers of the basis, radius R and height 2·R+D. A vehicle system associated with aircraft A may run one or more processes described herein (e.g., processes 200 and 300 described via FIGS. 2 and 3, respectively) to identify nearby aircraft potentially falling within the tile. If a possible collision is detected, countermeasures may be taken. For instance, a dedicated connection may be initiated by aircraft A with a colliding aircraft, for example, to agree on a shared path to avoid any physical collision. Also or alternatively, an autonomous evasive maneuver may be initiated. Further, according to the processes described herein (e.g., in relation to FIGS. 4 and 5), the aircrafts may keep their long-term identities private, i.e., they will broadcast only their randomly generated pseudonyms, while keeping private their long-term unique identities.

FIG. 7F illustrates an example embodiment of the above described privacy preserving collision avoidance system applied among swarms of autonomous vehicles, including drones, ships, cars, and any other autonomous mobile device. As shown in FIG. 7F, a swarm of five autonomous drones, represented as swarm A, may move together in a coordinated fashion. The drones in the swarm A may also share information (e.g., via a dedicated connection). In some aspects, the swarm A may be also hierarchically organized, with one autonomous vehicle elected as the swarm head 720, and instructing the other slaves about specific jobs. In this context, the autonomous vehicles in the swarm A may apply the privacy-preserving co-location techniques described herein to detect any autonomous drone (e.g., autonomous drone E) falling in the trajectory from the source point to the destination point.

In some embodiments, the tessellation logic can be designed to include all the entities in the swarm, to avoid that any drone in the swarm collide with nearby vehicles. In addition, when a response is received from any of the autonomous vehicles in the neighborhood, the swarm head can assign the processing of the response to the autonomous vehicle in the swarm that is more suitable to complete the computation in the most reduced time. For instance, with reference to the example shown in FIG. 7F, the drone at the center of the swarm could be elected as the swarm head 720, and can off-load the computation of the responses to the drone that has the less computational overhead in the swarm. In this way, the possible collision with drone E can be timely identified. Furthermore, either the swarm head 720 or any of the members can contact the drone E to agree on a shared strategy to avoid the collision. For instance, a dedicated connection may be initiated by swarm A with the colliding aircraft, to agree on a shared path to avoid any physical collision, or an autonomous evasive maneuver may be initiated. Furthermore, according to the privacy preserving collision avoidance techniques discussed herein, the smart vehicles may keep their long-term identities private, i.e., they will broadcast only their randomly generated pseudonyms, while keeping private their long-term unique identities.

As used herein, “about,” “approximately” and “substantially” are understood to refer to numbers in a range of numerals, for example the range of −10% to +10% of the referenced number, preferably −5% to +5% of the referenced number, more preferably −1% to +1% of the referenced number, most preferably −0.1% to +0.1% of the referenced number.

Furthermore, all numerical ranges herein should be understood to include all integers, whole or fractions, within the range. Moreover, these numerical ranges should be construed as providing support for a claim directed to any number or subset of numbers in that range. For example, a disclosure of from 1 to 10 should be construed as supporting a range of from 1 to 8, from 3 to 7, from 1 to 9, from 3.6 to 4.6, from 3.5 to 9.9, and so forth.

Without further elaboration, it is believed that one skilled in the art can use the preceding description to utilize the claimed inventions to their fullest extent. The examples and aspects disclosed herein are to be construed as merely illustrative and not a limitation of the scope of the present disclosure in any way. It will be apparent to those having skill in the art that changes may be made to the details of the above-described examples without departing from the underlying principles discussed. In other words, various modifications and improvements of the examples specifically disclosed in the description above are within the scope of the appended claims. For instance, any suitable combination of features of the various examples described is contemplated.

The invention is claimed as follows:

1. A collision avoidance system comprising:
a memory; and
a processor in communication with the memory, the processor configured to:
map location information of a first vehicle;
create a first cryptographic challenge encoding the location information of the first vehicle;
create first authentication materials;
transmit the first cryptographic challenge and the first authentication materials to a second vehicle;
receive a response from the second vehicle including a second cryptographic challenge and second authentication materials, the second cryptographic challenge encoding location information of the second vehicle;
verify if the response from the second vehicle is valid;
decode the second cryptographic challenge to determine the location information of the second vehicle;
determine whether a collision will happen based on the location information of the first vehicle and the location information of the second vehicle;
activate countermeasures in response to determining that a collision will happen, and
generate a location report signature.

2. The collision avoidance system of claim 1, wherein the processor is configured to create the first authentication materials by:
generating a one-time key; and
generate an ephemeral pseudonym for the first vehicle.

3. The collision avoidance system of claim 2, wherein the processor is further configured to encrypt the one-time key.

4. The collision avoidance system of claim 1, wherein the first vehicle is an autonomous vehicle.

5. The collision avoidance system of claim 4, wherein the autonomous vehicle is a car, aircraft, ship, or underwater vehicle.

6. The collision avoidance system of claim 1, wherein the processor is configured to activate countermeasures by causing agreement with the second vehicle on an alternate movement path for one or both of the first vehicle or the second vehicle to avoid collision.

7. The collision avoidance system of claim 1, wherein the processor is configured to activate countermeasures by causing the first vehicle to perform an autonomous evasive maneuver.

8. The collision avoidance system of claim 1, wherein the first vehicle comprises:
a radiofrequency (RF) communication subsystem; and
a processing subsystem;
wherein the processor is configured to perform the transmitting and the receiving using the RF communication system; and
wherein the processor is configured to perform the mapping the location information, the creating the first cryptographic challenge, the creating the first authentication materials, the verifying, the decoding, the determining whether the collision will happen, and the activating the countermeasures using the processing subsystem.

9. The collision avoidance system of claim 1, wherein the second vehicle comprises:
a second RF communication subsystem; and
a second processing subsystem.

10. A collision avoidance system comprising:
a memory; and
a processor in communication with the memory, the processor configured to:
receive a communication from a first vehicle including a cryptographic challenge and authentication materials, the cryptographic challenge encoding location information of the first vehicle;
verify that the communication from the first vehicle is valid;
map location information of a second vehicle;
create a second cryptographic challenge encoding the location information of the second vehicle;
create second authentication materials;
transmit the second cryptographic challenge and the second authentication materials to the first vehicle; and
generate a location report signature.

11. The collision avoidance system of claim 10, wherein the processor is further configured to, after verifying that the communication is valid:
decode the communication to receive a space tessellation associated with the first vehicle; and
map the location information of the second vehicle into a tile of the space tessellation associated with the first vehicle.

12. The collision avoidance system of claim 10, wherein the processor is further configured to:
generate a space tessellation associated with the second vehicle that is different from the space tessellation associated with the first vehicle; and
map the location information of the second vehicle into a tile of the space tessellation associated with the second vehicle.

13. The collision avoidance system of claim 10, further comprising:
a continuous integration (CI) operator; and
an authority;
wherein the processor is configured to receive the communication from the first vehicle via the CI operator;
wherein the processor is configured to verify that the communication from the first vehicle is valid via the authority.

14. The collision avoidance system of claim 10, wherein the communication from the first vehicle further includes an ephemeral pseudonym for the first vehicle, wherein the processor is further configured to:
link a long term identification for the first vehicle using the ephemeral pseudonym.

15. A method for collision avoidance that preserves the privacy of autonomous vehicles, the method comprising:
mapping, by a first vehicle system having a processor and associated with a first autonomous vehicle, a location information for the first autonomous vehicle on a first space tessellation;
creating, by the first vehicle system, a first cryptographic challenge encoding the location information of the first autonomous vehicle;
creating, by the first vehicle system, first authentication materials including at least an encrypted key;
detecting, by the first vehicle system, a second autonomous vehicle within a proximity of the first autonomous vehicle;
transmitting, by the first vehicle system, the first cryptographic challenge and the first authentication materials to a second vehicle system associated with a second autonomous vehicle; and
generating, by the first vehicle system processor, a location report signature.

16. The method of claim 15, further comprising:
receiving, by the second vehicle system and from the first vehicle system, a message comprising the first cryptographic challenge and the first authentication materials;
verifying, by the second vehicle system, the message;
mapping, by the second vehicle system, location information of the second autonomous vehicle;
creating, by the second vehicle system, a second cryptographic challenge encoding the location information of the second autonomous vehicle;
creating, by the second vehicle system, second authentication materials; and
transmitting, by the second vehicle system to the first vehicle system, a response comprising the second cryptographic challenge and the second authentication materials to the first vehicle system.

17. The method of claim 16, further comprising:
receiving, by the first vehicle system, the response;
verifying, by the first vehicle system, that the response from the second vehicle system is valid;
decoding, by the first vehicle system, the second cryptographic challenge to determine the location information of the second autonomous vehicle; and
determining, by the first vehicle system, whether a collision will happen based on the location information of the first autonomous vehicle and the location information of the second autonomous vehicle.

18. The method of claim 17, further comprising:
activate countermeasures in response to determining that a collision will happen.

19. The method of claim 18, wherein activating countermeasures comprises one or more of:
agreeing, by the first vehicle system and the second vehicle system, on an alternate movement path for one or both of the first autonomous vehicle or the second autonomous vehicle to avoid collision; or
performing, by the first vehicle system, an autonomous evasive maneuver.
